(19) United States
(12) Patent Application Publication
(10) Pub. No.: US 2009/0127285 A1
(43) Pub. Date: May 21, 2009

(54) DISPENSING DEVICE

(75) Inventors: Anthony Robert Hoare, Rugby (GB); Ian Darby, Lercester (GB)

Correspondence Address: SMITH-HILL AND BEDELL, P.C., 16100 NW CORNELL ROAD, SUITE 220, BEAVERTON, OR, 97006, US

(73) Assignee: D.S. SMITH PLASTICS LIMITED, Rugby, Warwickshire (GB)

(21) Appl. No.: 12/097,588

(22) PCT Filed: Dec. 13, 2006
(86) PCT No.: PCT/GB2006/004680

§ 371 Date: Jul. 17, 2008

(30) Foreign Application Priority Data
Dec. 16, 2005 (GB) 0525587.2

(51) Int. Cl. B67D 5/00; B67D 3/00; B67D 3/04

(52) U.S. Cl. 222/83; 222/509; 222/518

(57) ABSTRACT

A dispensing device usable for instance for dispensing liquids from a container is operated by a resilient button which causes pegs to slide over respective cam surfaces between open and closed conditions.

This invention relates to dispensing devices. More particularly, but not exclusively, the invention relates to dispensing devices for dispensing liquids from containers. Embodiments of the invention relate to tap mechanisms.

Dispensing devices for containers of liquids often do not operate in the most efficient manner.

According to the invention, there is provided a dispensing device comprising a main body having an outlet, a sealing member moveable between a closed condition in which the sealing member closes the outlet, and an open condition in which the outlet is open, a cam arrangement to guide the movement of the sealing member, and urging means to urge the sealing member between the open and closed conditions.

The sealing member preferably comprises a seal portion to engage the main body around the outlet, thereby closing the outlet. The sealing member may include a main portion, and the seal portion may extend from the main portion.

The sealing member may include an engagement member to engage the cam arrangement, thereby guiding the movement of the sealing member. Preferably, the cam arrangement comprises a cam surface. The engagement member may engage the cam surface for slidable movement across the cam surface during movement of the sealing member, thereby effecting the aforesaid guiding of the sealing member.

The device may be configured such that in the closed condition the urging means urges the engagement member against the cam surface which urges the seal portion against the main body around the outlet.

The cam arrangement may comprise first and second opposed cam surfaces to effect the aforesaid guiding of the sealing member.

The sealing member may comprise first and second engagement members to engage the first and second cam surfaces for slidable movement along the cam surfaces. Desirably, the first engagement member is slidably moveable across the first cam surface. Desirably, the second engagement member is slidably moveable across the second cam surface. The second engagement member may substantially engage the first and second cam surfaces when the sealing member is in the closed condition and the first and second cam surfaces may define between them a channel.

The first cam surface may be arranged such that it is engaged by the first engagement member when the sealing member is in the closed condition.

In an alternative arrangement a single engagement member may be provided. The engagement member may substantially engage the first and second cam surfaces when the sealing member is in the closed condition and the first and second cam surfaces may define between them a channel. Once the sealing member has moved from the closed condition the engagement member may only engage the second cam surface.

The first and second cam surfaces desirably face each other. The first cam surface may comprise a concavity along which the respective engagement member can slide to the closed condition, or may comprise an inclined surface along which the respective engagement member can slide to the closed condition.

The second cam surface may comprise a first portion along which the respective engagement member can slide. The first portion may be a convexity or an inclined surface. Preferably, the first portion of the second cam surface is arranged such that it is engaged by the respective engagement member when the sealing member is in the closed condition.

The second cam surface may comprise a substantially straight portion, which may extend from the first portion of the second cam surface. The substantially straight portion is preferably generally parallel with the direction of movement of the sealing member.

Preferably, the respective engagement member is slidable along the substantially straight portion of the second cam surface when the sealing member has moved from the closed condition.

The urging means may comprise a resilient member. The resilient member may comprise a button, which can be depressed. The urging means preferably can be depressed to move the sealing member to the open condition. The sealing member may include a transmission member to transmit the force of the urging means to the main portion of the sealing member. The transmission member may comprise an elongate part which may project from the main portion of the sealing member.

The sealing member may comprise a piercing element to pierce a membrane on the container to allow fluid to flow from the container into the dispensing device. The piercing element may comprise a plurality of elements. The piercing element is preferably provided at the opposite end of the main portion of the sealing member to the transmission member.

The or each engagement member on the sealing member may be in the form of a peg.

Embodiments of the invention will now be described by way of example only, with reference to the accompanying drawings, in which:

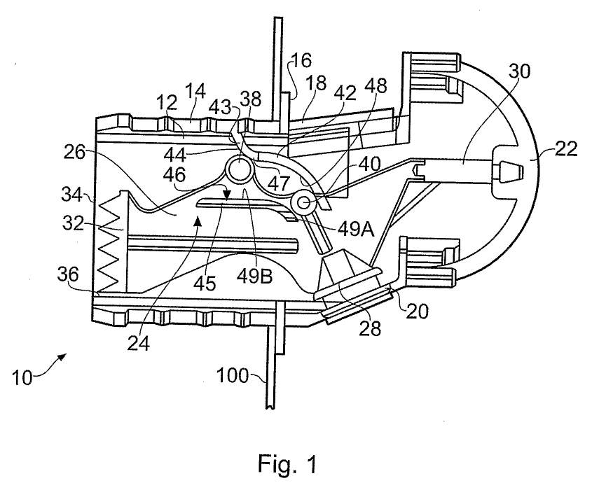

FIG. 1 is a diagrammatic sectional side view of a first dispensing device in a closed condition;

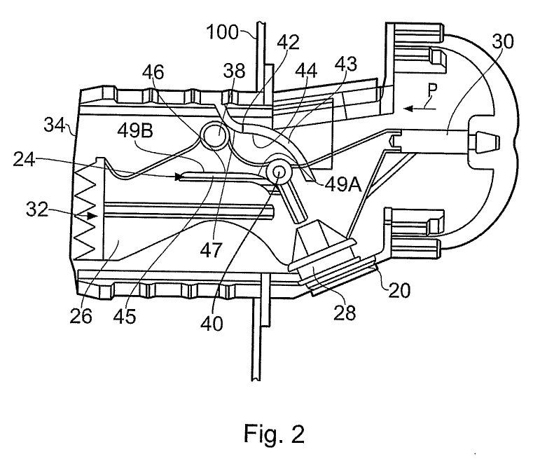

FIG. 2 is a diagrammatic sectional side view of the dispensing device shown in FIG. 1 showing the sealing member moving from the closed condition;

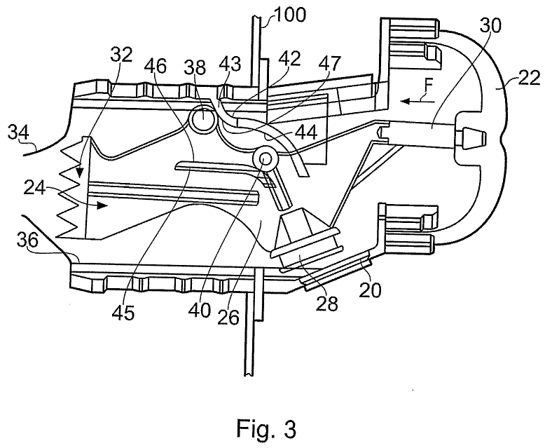

FIG. 3 is a diagrammatic sectional side view of the dispensing device shown in FIG. 2 after further movement of the sealing member from the closed condition;

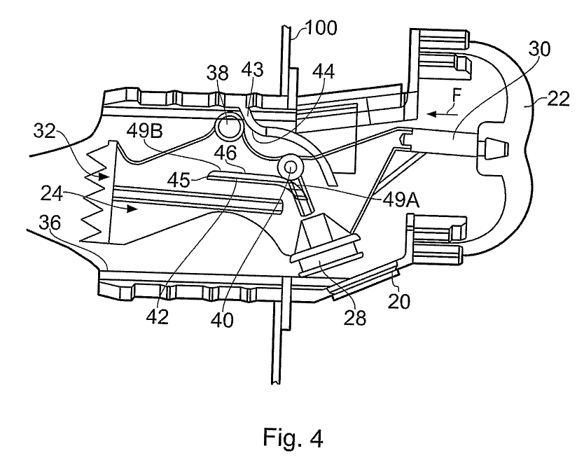

FIG. 4 is a diagrammatic sectional side view of the dispensing device shown in FIG. 3 after further movement of the sealing member from the closed condition;

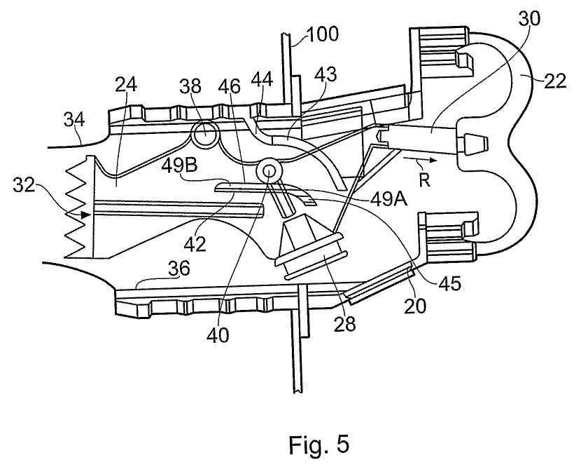

FIG. 5 is a diagrammatic sectional side view of the dispensing device shown in FIG. 4 with the sealing member in the open condition; and

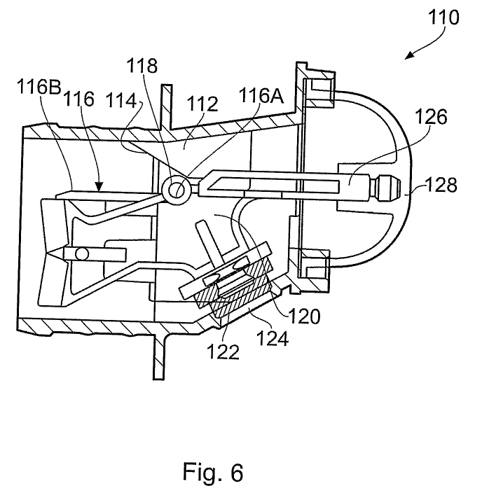

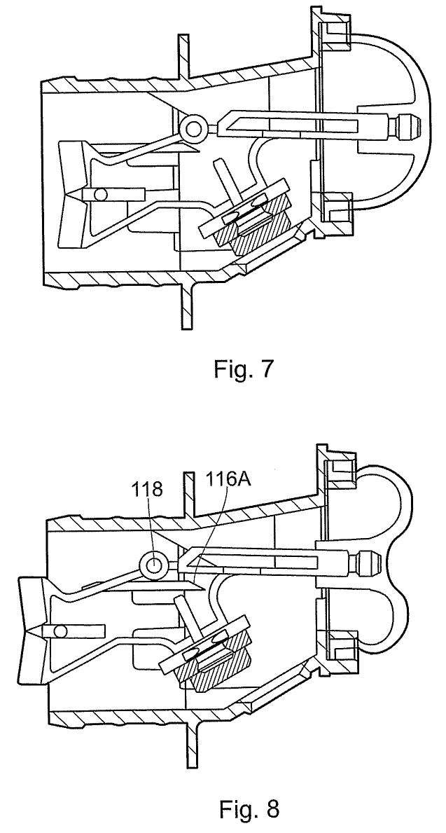

FIGS. 6 to 9 are diagrammatic sectional side views of a second dispensing device moving respectively from a closed condition to an open condition.

Referring to FIG. 1, there is shown a first dispensing device 10 mountable on a container 100. Only the part of the container 100 attached to the dispensing device 10 is shown. The container 100 could be for example, a bag of a bag in box arrangement. The dispensing device 10 is in the form of a tap mechanism, and comprises a main body 12 comprising a generally cylindrical portion 14 having a radially outwardly extending flange 16 thereon at which the main body 12 is attached in an aperture in the container 100.

The main body 12 also includes an angled portion 18 extending from the cylindrical portion 14. The flange 16 is arranged at the junction between the cylindrical portion 14 and the angled portion 18. The angled portion 18 defines an outlet aperture 20 through which fluid in the container 100 can flow. Urging means in the form of a resilient button 22 is provided at the outer end of the angled portion 18. The resilient button 22 is formed of a suitable elastomeric material.

The dispensing device 10 also includes a sealing member 24 arranged within the main body 14. The sealing member 24 comprises a main portion 26 having a seal portion 28 thereon. In FIG. 1, the seal portion 28 is received within the aperture 20 and sealed against the main body around the outlet aperture 20.

The sealing member 24 also includes a transmission member 30, in the form of an elongate projection, which transmits the force applied to the elastomeric button 22 when it is depressed.

At the opposite end of the main portion 26 of the sealing member 24, there is provided a piercing element 32 to pierce a membrane 34 adhered to the main body and extending across a rear opening 36 of the main body 12. The rear opening 36 allows fluid in the container 100 to flow in to the dispensing device 10.

The sealing member 24 also includes a first engagement member in the form of a first peg 38, and a second engagement member in the form of a second peg 40.

The dispensing device 10 also includes a cam arrangement 42 comprising a first cam member 43 having a first cam surface 44 along which the first peg 38 can slide, and a second cam member 45 having a second cam surface 46 along which the second peg 40 can slide. The first and second cam surfaces 44, 46 interact with the first and second pegs 38, 40 to guide the sealing member when it is moved from an open condition shown in FIG. 1 to a closed condition shown in FIG. 5.

The first cam surface 44 includes a convexity 47 engaged by the first 38 when the sealing member 24 is in the closed condition (see FIG. 1) or slightly spaced therefrom (see FIGS. 2 and 3). The first cam surface 44 also includes a concavity 48, the end region of which engages the second peg 40 when the sealing member 22 is in the closed condition, shown in FIG. 1.

The second cam surface 46 comprises a convexity 49A and a straight portion 49B. The second peg 40 slidably engages the convexity 49A when the sealing member 22 is in the closed condition (see FIG. 1) or is slightly spaced therefrom (see FIGS. 2 and 3). The second peg 40 slidably engages the straight portion 49B as the sealing member moves away from the closed condition to the fully open condition (see FIGS. 4 and 5).

Referring to FIG. 2, there is shown the dispensing device 10 of FIG. 1 in which the button 22 has been partially depressed. The force depressing the button 22 is transmitted as shown by the arrow F by the transmission member 30 to the main portion 26 of the sealing member 24 to move the sealing member 24 also in the direction of the arrow F. The movement of the sealing member 24 in the direction of the arrow F moves the piercing element 32 such that it engages the membrane 34. Also, the sealing portion 28 is moved away from the aperture 20, thereby opening the aperture 20.

As can be seen, the first peg 38 slides across the convexity 47 of the cam surface 44, and the second peg 40 slides across the convexity 49A of the second cam surface 46. This moves the sealing member 24 along a path controlled by the first and second cam surfaces 44, 46 until, as shown in FIG. 3, the first peg 38 starts to move away from the first cam surface 44 and the second peg 40 commences its sliding engagement with the straight portion 49B of the second cam surface 46.

Also as shown in FIG. 3, the piercing element 32 pierces the membrane 34. The seal portion 28 is moved further away from the aperture 20 by the continued pressing of the button 22.

Further depression of the button 22 moves the sealing member 24 further in the direction indicated by the arrow F to ensure complete piercing of the membrane 34 by the piercing element 32. In the position shown in FIG. 4, the first peg 38 is moved fully away from the first cam surface 46, and the second peg 40 continues its sliding movement across the straight portion 49A of the first cam surface 34.

FIG. 5 shows the sealing member 24 at the limit of its movement in the direction of the arrow F, with the sealing member now in its fully open condition and the aperture 20 fully open. The second peg 40 is still in contact with the straight portion 49A of the second cam surface 44, whereby the second cam surface 46 continues to guide the movement of the sealing member 24.

In order to close the aperture 20, the sealing member must be returned to this closed condition as shown in FIG. 1. This is allowed to happen by simply releasing the button 22, which due to its resilient nature returns to its original condition and moves the sealing member 24 in the direction of the arrow R, shown in FIG. 5 to return the sealing member 24 back to the position shown in FIG. 1.

There is thus described an effective and simple dispensing device 10 for allowing the dispensing of fluids from within a container 100. The preferred embodiment has the advantage that the arrangement of cam surfaces 44, 46 and pegs 38, 40 guides the piercing element 32 directly towards the membrane 34 to allow the membrane to be pierced. Similarly, the arrangement of cam surfaces 44, 46 and pegs 38, 40 allows the sealing portion 28 of the sealing member 24 to seal within an aperture 20 to fully close the dispensing device 10.

FIGS. 6 to 9 show a second dispensing device 110 which is similar in many respects to the device 10, and therefore only the differences will be described. With the device 110 the cam arrangement 112 comprises first and second cam surfaces 114, 116. The first cam surface 114 is straight and inclined downwardly and to the left as shown in the drawings. The second cam surface 116 comprises a first portion 116A which is inclined and faces the first cam surface 114 to define a channel therebetween. The remainder 116B of the second cam surface 116 extends to the left as shown in the drawings and is substantially horizontal.

A single peg 118 is provided on the main portion 120. The main portion also mounts a sealing member 122 for closing an aperture 124. The main portion 120 is connected by a transmission member 126 to a button 128.

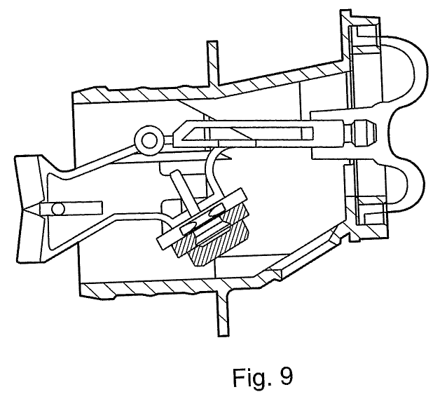

The device 110 operates in a generally similar manner to the device 10, with the resilience of the button 128 pulling the main portion 120 towards the right as shown in a rest position, such that the sealing member 122 closes the aperture 124. When the button 128 is pressed the peg 118 moves up the channel between the cam surfaces 114 and 116, moving the sealing member 122 away from the aperture 124. Further depression of the button 128 causes the peg 118 to move off the first cam surface 114 and along the second part 116B of the second cam surface 116 as shown in FIGS. 8 and 9. Obviously once the button 128 is no longer pressed the peg 118 will return along the second part 116B of the second cam surface 116 to engage again also with the first portion 116A and the first cam surface 114, causing the sealing member 122 to close the aperture 124.

Various other modifications can be made without departing from the scope of the invention. For example, the dispensing device 10 could be devoid of a piercing element, for example where the dispensing arrangement 10 does not have a membrane 34.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-39. (canceled)

40. A dispensing device comprising a main body having an outlet, a sealing member moveable between a closed condition in which the sealing member closes the outlet, and an open condition in which the outlet is open, a cam arrangement to guide the movement of the sealing member, and urging means to urge the sealing member between the open and closed conditions, the sealing member including an engagement member to engage the cam arrangement, thereby guiding the movement of the sealing member, the cam arrangement comprising first and second opposed cam surfaces to effect the aforesaid guiding of the sealing member.

41. A device according to claim 40, wherein the sealing member comprises a seal portion to engage the main body around the outlet, thereby closing the outlet.

42. A device according to claim 41, wherein the sealing member includes a main portion, with the seal portion extending from the main portion.

43. A device according to claim 40, wherein the sealing member comprises first and second engagement members to engage the first and second cam surfaces for slidable movement along the cam surfaces, with first engagement member is slidably moveable across the first cam surface, and second engagement member is slidably moveable across the second cam surface.

44. A device according to claim 43, wherein the second engagement member substantially engages the first and second cam surfaces when the sealing member is in the closed condition.

45. A device according to claim 40, wherein the first cam surface is arranged such that it is engaged by the first engagement member when the sealing member is in the closed condition.

46. A device according to claim 40, wherein the first and second cam surfaces face each other and define between them a channel.

47. A device according to claim 40, wherein the engagement member substantially engages the first and second cam surfaces when the sealing member is in the closed condition.

48. A device according to claim 40, wherein the first cam surface comprises a concavity along which the respective engagement member can slide to the closed condition.

49. A device according to claim 40, wherein the first cam surface comprises an inclined surface along which the respective engagement member can slide to the closed condition.

50. A device according to claim 40, wherein the second cam surface comprises a first portion along which the respective engagement member can slide.

51. A device according to claim 50, wherein the first portion is a convexity.

52. A device according to claim 50, wherein the first portion is an inclined surface.

53. A device according to claim 50, wherein the first portion of the second cam surface is arranged such that it is engaged by the respective engagement member when the sealing member is in the closed condition.

54. A device according to claim 50, wherein the second cam surface comprises a substantially straight portion, which extends from the first portion of the second cam surface.

55. A device according to claim 54, wherein the substantially straight portion is generally parallel with the direction of movement of the sealing member.

56. A device according to claim 54, wherein the respective engagement member is slidable along the substantially straight portion of the second cam surface when the sealing member has moved from the closed condition.

57. A device according to claim 40, wherein the urging means comprises a resilient member.

58. A device according to claim 57, wherein the resilient member comprises a button which can be depressed to move the sealing member to the open condition.

59. A device according to claim 42, wherein the sealing member includes a transmission member to transmit the force of the urging means to the main portion of the sealing member.

60. A device according to claim 59, wherein the transmission member comprises an elongate part which projects from the main portion of the sealing member.

61. A device according to claim 40, wherein the sealing member comprises a piercing element to pierce a membrane on the container to allow fluid to flow from the container into the dispensing device.

62. A device according to claim 61 wherein the piercing element is provided at the opposite end of the main portion of the sealing member to s transmission member which transmits the force of the urging means to the main portion of the sealing member.

63. A device according to claim 40, wherein the or each engagement member on the sealing member is in the form of a peg.
